(19) United States
(12) Patent Application Publication
(10) Pub. No.: US 2003/0008196 A1
(43) Pub. Date: Jan. 9, 2003

(54) Fuel cell

(76) Inventors: Helge Wessel, Mannheim (DE); Michael Bender, Ludwigshafen (DE); Klaus Harth, Altleiningen (DE); Andreas Fischer, Ludwigshafen (DE); Markus Holzle, Kirchheim (DE)

Correspondence Address: KEIL & WEINKAUF, 1350 CONNECTICUT AVENUE, N.W., WASHINGTON, DC, 20036, US

(21) Appl. No.: 10/179,249

(22) Filed: Jun. 26, 2002

(30) Foreign Application Priority Data
Jun. 27, 2001 (DE) 10130828.0

(51) Int. Cl. H01M 4/86; H01M 4/96

(52) U.S. Cl. 429/40; 429/38; 429/42; 429/44

(57) ABSTRACT

The invention relates to a fuel cell (1) having two electrodes (2) and an ion exchanger membrane (6), where the electrodes (2) are each provided with an electrocatalytic layer (4) and at least one gas channel for a reaction gas (7). The fuel cell has at least one additive which prevents the formation of peroxides and/or destroys peroxides. The invention furthermore relates to the use of at least one additive in or on electrodes (2) of a fuel cell (1) having an ion exchanger membrane (6), where the electrodes (2) are each provided with an electrocatalytic layer (4) and at least one gas channel for a reaction gas (7). The at least one additive serves for the prevention of the formation and/or for the destruction of peroxides on or in the electrodes (2).

The present invention relates to a fuel cell, in particular a polymer electrolyte membrane fuel cell having catalytically active electrodes.

Fuel cells are energy converters which convert chemical energy into electrical energy. In a fuel cell, the principle of electrolysis is reversed. Various types of fuel cell are known today, generally differing from one another in the operating temperature. However, the construction of the cells is basically the same in all types. They generally consist of two electrodes, an anode and a cathode, at which the reactions take place, and an electrolyte between the two electrodes. This has three functions. It provides ionic contact, prevents electrical contact and also ensures that the gases fed to the electrodes are kept separate. The electrodes are generally supplied with gases which are reacted in a redox reaction. For example, the anode is supplied with hydrogen and the cathode with oxygen. In order to ensure this, the electrodes are contacted with electrically conductive gas distribution devices. These are, in particular, plates having a grid-like surface structure consisting of a system of fine channels. The overall reaction in all fuel cells can be divided into an anodic part and a cathodic part. There are differences between the different cell types with regard to the operating temperature, the electrolyte employed and the possible fuel gases.

Basically, a distinction is made between low-temperature fuel cells and high-temperature systems. The low-temperature fuel cells are generally distinguished by a very high power density. However, their waste heat is only of low utility owing to the low temperature level. To this extent, these fuel cells cannot be used for downstream energy conversion processes, but are appropriate for mobile use through decentral application of small outputs. In the high-temperature systems, power station stages, for example, can be connected downstream in order to recover electrical energy from the waste heat or to utilize it as process heat.

In particular, the polymer electrolyte fuel cell and the phosphoric acid fuel cell are currently attracting considerable interest both for stationary use and for mobile applications and are on the brink of broad commercialization.

According to the current state of the art, all fuel cells have gas-permeable, porous, so-called three-dimensional electrodes. These are known by the collective term gas diffusion electrodes (GDE). The respective reaction gases are passed through these electrodes to the vicinity of the electrolytes. The electrolyte present in all fuel cells ensures ionic current transport in the fuel cell. It also has the job of forming a gas-tight barrier between the two electrodes. In addition, the electrolyte guarantees and supports a stable three-phase layer in which the electrolytic reaction is able to take place. The polymer electrolyte fuel cell employs organic ion exchanger membranes, in industrially implemented cases in particular perfluorinated cation exchanger membranes, as electrolyte.

According to the concept of today's fuel cells, the reaction gases are fed from the reverse side of the electrode, i.e. the side in each case facing away from the counterelectrode, to the electrochemically active zone via a gas distributor system. Under load, both the gas transport and the ion migration take place perpendicularly to the specified electrode geometry.

Cathodic reduction of the oxygen has proven problematic under operating conditions: highly reactive peroxidic oxygen species (for example. HO., HOO.), which diffuse to the proton-permeable membrane and irreversibly damage it, are formed at the cathodic electrode material of the fuel cell, as described in the prior art. Corresponding degradation processes are described, for example, in EPR investigation of HO. radical initiated degradation reactions of sulfonated aromatics as model compounds for fuel cell proton conducting membranes, G. Hübner, E. Roduner, J. Mater. Chem., 1999, 9, pp. 409-418.

Owing to these degradation processes, it is currently necessary to employ perfluorinated cation exchanger materials as electrolyte. Although these materials are distinguished by a certain resistance to peroxidic species, they have, however, the disadvantages of high costs, complex production due to the handling of fluorine or other fluorinating agents and are ecologically dubious, since reprocessing and/or recycling are not possible.

It is an object of the present invention to provide a fuel cell in which the disadvantages inherent in the described operating principle of current fuel cells are avoided.

We have found that this object is achieved in accordance with the invention by a fuel cell having two electrodes and an ion exchanger membrane, where the electrodes are each provided with an electrocatalytic layer and at least one gas channel for a reaction gas, and each electrocatalytic layer comprises at least one standard catalyst, wherein the fuel cell has at least one additive which prevents the formation of peroxides under fuel-cell conditions and/or decomposes peroxides. In particular, the electrodes with the electrocatalytic layers have at least one additive.

In this connection, the term “standard catalyst” is taken to mean a catalyst which is present in the electrocatalytic layers of fuel cells in the prior art and is necessary for reducing the activation energy of the fuel-cell reaction. The standard catalysts employed are, for example, noble metals, in particular platinum.

It has been found that the service life or operating duration and economic efficiency of fuel cells can be permanently increased through additives having deperoxidation-active properties introduced onto or into the electrode material. The term “deperoxidation-active” here is taken to mean the property of preventing the formation of peroxides and subsequently decomposing peroxides that have already formed. Peroxides in this connection are all compounds of the type R—O—O—R and the associated free radicals (RO. or ROO.), where R is preferably H. HOO. is, for example, a peroxidic free radical of H₂O₂ (hydrogen peroxide). By application of suitable deperoxidation-active compounds and/or elements into or onto the fuel-cell electrodes, rapid degradation or suppression of the formation of peroxides surprisingly takes place under fuel-cell conditions. Irreversible damage to the ion-exchanger membrane by reactive peroxides is no longer observed. This is surprising since, in accordance with the principle of microreversibility, substances which decompose peroxides can also form peroxides. For example, platinum functions as peroxide former under fuel-cell conditions owing to the permanent supply of O₂. Under other conditions, it is employed for peroxide destruction. Only through the introduction of further deperoxidation-active additives are the peroxides formed on the platinum in the fuel cell successfully decomposed or their formation suppressed.

The present invention furthermore relates to the use of at least one additive in or on electrodes of a fuel cell having an ion exchanger membrane, where the electrodes are each provided with an electrocatalytic layer and at least one gas channel for a reaction gas. The at least one additive here serves for prevention of the formation or decomposition of peroxides on or in the electrodes.

The present invention considerably improves the economic efficiency, the efficiency and the service life of the fuel cells according to the invention compared with the fuel cells disclosed hitherto. Furthermore, the prevention of the occurrence of aggressive peroxides reduces the chemical stability requirements of the cation exchanger membranes and enables the use of ecologically acceptable, inexpensive, conventional materials.

The prior art describes numerous examples of deperoxidation-active elements and compounds which are suitable as additives in the present invention. The active components mentioned for such elements and compounds are principally the metals Co, Fe, Cr, Mn, Cu, V, Ru, Pd, Ni, Mo and W. Said metals are employed either as homogeneous catalysts, in the form of salts, oxides or organometallic complexes, or in heterogeneous form in combination with various support substances (for example C, SiO₂, Al₂O₃, zeolites or heteropolyacids).

The following publications give in excerpts an overview of this state of the art:

U.S. Pat. No. 3,053,857 teaches that the peroxides remaining in the synthesis of glycidic acid amide are destroyed using palladium on carbon.

EP-A 0 025 608 describes that peroxides, such as Na perborate or H₂O₂, can be destroyed by materials containing heavy metals, such as zeolites or bentonites containing Cu, Mn, Ni, V or Fe.

EP-A 0 215 588 describes the removal of residual peroxides of t-butanol using Ni, Pt and/or Pd catalysts.

U.S. Pat. No. 4,551,553 describes the destruction of hydroperoxides using homogeneous Cr/Ru catalysts.

U.S. Pat. No. 3,306,846 recommends the removal of peroxides in gasolines with the aid of PbO₂ or MnO₂.

DE-A 43 33 328 describes a catalytic process for the controlled decomposition of (organic) peroxides. The catalysts mentioned are mixtures of oxides of the elements Mn, Cu, Fe, Ni, Co, Ce, Mo, V and W.

In Selective decomposition of cyclohexyl hydroperoxide to cyclohexanone catalyzed by chromium aluminophosphate-5, J. D. Chen. J. Dakka, R. A. Sheldon, Applied Catalysis A: General, 108 (1994) L1-L6, the selective destruction of cyclohexyl hydroperoxide on Cr-substituted aluminophosphates is described.

The present invention is explained in greater detail below with reference to the drawing, in which:

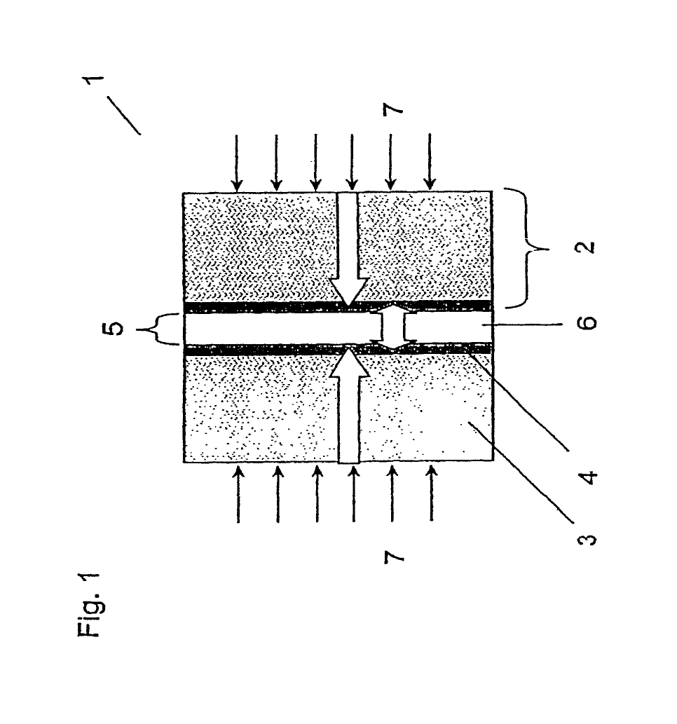

FIG. 1 shows a diagrammatic view of the construction of a fuel cell in accordance with the prior art.

FIG. 1 shows a diagrammatic view of a fuel cell 1 in accordance with the current state of the art. In general, a fuel cell 1 of this type consists of two gas-permeable, porous electrodes 2 located opposite one another which are known by the term gas diffusion electrodes (GDE). They comprise a porous, electrically conductive substrate 3 and an electrocatalytic layer 4. A membrane 6 is located in the gap 5 provided between the electrodes 2. This membrane at the same time contains the electrolyte. The electrolyte ensures ionic current transport in the fuel cell. It forms a gas-tight barrier between the two electrodes 2 and thus forms an electrochemically active zone within which the electrolysis is able to take place. In polymer electrolyte fuel cells, organic ion exchanger membranes, for example perfluorinated cation exchanger membranes, are employed. The intimate contact between the membrane 6 and the gas diffusion electrodes 2 is achieved by complex techniques, for example by “hot pressing” and further sub-steps. The reaction gases 7 are fed from the reverse side of the electrode 2, i.e. the respective side facing away from the counterelectrode, to the electrochemically active zone via gas distributor systems. Thus, gas transport 8 (thick single-headed arrows) and ion transport 9 (thick double-headed arrow) occur in parallel in overall terms. Two key components, in particular of the polymer electrolyte membrane (PEM) fuel cell type, are thus the expensive proton-permeable organic ion exchanger membrane 6, which has hitherto had high sensitivity to impurities and/or reactive chemical compounds, and the electrocatalytic layer 4 of the electrodes 2, which has a high content of Pt (20% by weight) and possibly further noble metals, for example Ru.

In a preferred embodiment of the present invention, the at least one additive which prevents the formation of peroxides and/or decomposes peroxides is a constituent of the electrocatalytic layer 4. Since the individual part-electrodes can be treated in any desired manner before assembly to give the overall electrode 2, they can be provided with catalysts in a suitable manner. This is carried out, in particular, by coating with electrocatalytically active materials (standard catalysts), for example with noble metals, such as platinum, palladium, silver, ruthenium or iridium, or combinations thereof and with deperoxidation-active compounds and/or elements.

This can be carried out, in particular, by electrocoating and/or electroless metal deposition and/or precipitation and/or impregnation techniques, as described in the prior art.

The electrocatalytic layer 4 accordingly comprises at least one standard catalyst. In a preferred embodiment of the present invention, in which the at least one additive is a constituent of the electrocatalytic layer 4 comprising at least one standard catalyst, the at least one additive is preferably present, based on the at least one standard catalyst, in a ratio by weight of from 1:10 to 1:0.5, particularly preferably in a weight ratio of from 1:5 to 1:1.

In a further preferred embodiment of the present invention, the at least one additive is in the form of a coating on the electrodes 2. In another preferred embodiment of the present invention, the at least one additive is in each case distributed in the entire electrodes 2.

The at least one additive for preventing the formation or decomposition of peroxides preferably comprises at least one element or at least one compound from the groups consisting of metallic transition elements of the Periodic Table of the Elements, i.e. from groups IIIb, IVb, Vb, VIb, VIIb, VIIIb, Ib and IIb, or at one least metallic element or at least one compound from main group 4 (IVa) of the Periodic Table of the Elements. The at least one additive comprises, in particular, at least one of the elements Co, Fe, Cr, Mn, Cu, V, Ru, Pd, Ni, Mo, Sn or W. These elements have the requisite deperoxidation-active properties.

In a preferred embodiment of the present invention, the elements present in the at least one additive are in elemental form and/or in the form of salts. The elements may be in discrete form or in the form of alloy constituents in or on the electrodes. Furthermore, the elements present in the at least one additive may be in the form of oxides and/or organometallic complexes. Combinations of all said forms of the elements present in the at least one additive are also conceivable. The elements and/or compounds present in the at least one additive are preferably in heterogeneous form in combination with at least one support substance. A support substance from the group consisting of C, SiO₂, Al₂O₃, zeolites and heteropoly-acids is preferably selected.

The ion exchanger materials used in the present invention may comprise, for example, the following polymer materials or mixtures thereof:

Perfluorinated and/or partially fluorinated polymers, such as Nafion® (Dupont; USA), “Dow Experimental Membrane” (Dow Chemicals, USA), Aciplex-S® (Asahi Chemicals; Japan); Raymion® (Chlorine Engineering Corp.; Japan); “Raipore R-1010” (Pall Rai Manufacturing Co.; USA).

However, preference is given to polymer materials which comprise no fluorinated constituents, for example sulfonated phenol-formaldehyde resins (linear or cross-linked); sulfonated polystyrene (linear or crosslinked); sulfonated poly-2,6-diphenyl-1,4-phenylene oxides; sulfonated polyaryl ether sulfones; sulfonated polyarylene ether sulfones; sulfonated polyaryl ether ketones; phosphonated poly-2,6-dimethyl-1,4-phenylene oxides.

Particular preference is given to polymer materials which comprise the following constituents (or mixtures thereof):

Polybenzimidazole-phosphoric acid; sulfonated polyphenylenes; sulfonated polyphenylene sulfide; polymeric sulfonic acids of the type polymer-SO₃X (X=NH₄⁺, NH₃R⁺, NH₂R₂⁺, NHR₃⁺, NR₄⁺).

In addition to the polymer materials listed above, the ion exchanger materials used may comprise further inorganic and/or organic constituents (for example silicates, minerals, clays or silicones) which have a positive effect on the properties of the ion exchanger material (for example conductivity).

### EXPERIMENT EXAMPLES

For the examples shown below, fuel cells according to the invention with electrocatalysts comprising deperoxidation-active additives and with comparative catalysts (standard catalysts) were produced and used. The catalysts with additives which suppress the formation of reactive peroxides under fuel-cell conditions, and the comparative catalysts (standard catalysts) from the prior art are compared with one another below with respect to their (electro)chemical properties in the application for fuel cells. The support material used for the electrocatalysts in the fuel cells according to the invention was the furnace black XC-72 from the manufacturer Cabot Inc. (Boston, Mass.). The particle size determination of the metal crystallites of the electrocatalysts was carried out by X-ray diffraction.

### Example 1

3.93 g of Cu(II) acetate, 14.97 g of ethylenediaminetetraacetic acid, for example Titriplex® II, and 10 ml of aqueous ammonia solution (25% strength by weight) were made up to 200 ml of overall solution with demineralized H₂O. A suspension of 10 g of Vulcan XC-72 furnace black from the manufacturer Cabot Inc. (Boston, Mass.) in 50 ml of demineralized H₂O, as well as 0.1 ml of pyridine and 2.9 ml of aqueous formaldehyde (37% strength by weight) was added. A pH of 12 was set using aqueous sodium hydroxide solution (40% strength by weight). The reaction mixture was warmed at 70° C. for 1 hour. The catalyst was subsequently filtered off with suction via a glass frit, dried at 80° C. for 4 hours and calcined at 200° C. for 2 hours.

For Pt deposition, 4.94 g of aqueous hexachloroplatinic acid solution (25% strength by weight) and 150 ml of demineralized H₂O were introduced into a 500 ml stirred apparatus, Cu-containing carbon black was added, and the mixture was stirred at 85° C. for 2 hours. A pH of 2.75 was then set using HCl solution (10% strength by weight). After 3.40 g of aqueous Na acetate solution (25% strength by weight) and 8 ml of conc. formic acid had been added, the mixture was stirred for 24 hours, the catalyst was filtered off with suction via a glass frit, washed with 1000 ml of demineralized H₂O until neutral and dried at 80° C. for 4 hours. The electrocatalyst obtained has a platinum and copper content of 10% by weight each. X-ray analysis of this material clearly confirms the presence of an alloyed Pt/Cu system (Pt/Cu crystallite size: 3.0 nm); diffraction reflections of the pure metals are not present.

### Example 2

An electrocatalyst comprising 20% by weight of platinum and 5% by weight of copper was prepared analogously to Example 1. The Pt/Cu crystallite size is 3.5 nm.

### Example 3

An electrocatalyst comprising 10% by weight of platinum and 5% by weight of copper was prepared analogously to Example 1. The Pt/Cu crystallite size is 3.1 nm.

### Example 4

An electrocatalyst comprising 20% by weight of platinum and 5% by weight of tin was prepared analogously to Example 1. The Pt/Cu crystallite size is 4 nm.

### Example 5

5.58 g of manganese acetate were dissolved in 50 ml of demineralized H₂O. 10 g of Vulcan XC-72 furnace black were subsequently soaked with this solution in accordance with the water take-up. After a standing time of 2 hours, the material was filtered off with suction via a glass frit, dried at 80° C. for 4 hours and calcined at 250° C. for 2 hours. Platinum was subsequently deposited on this material as described under Example 1. An electrocatalyst comprising 10% by weight of platinum and 10% by weight of manganese was obtained. The platinum crystallite size is 4.8 nm.

### Comparative Example C1

For comparative purposes, a commercially available Pt supported catalyst (from the manufacturer E-TEK Div. of De Nora Inc., Sommerset, N.J.) (Pt content: 20% by weight) was employed. It represents the state of the art in this area.

### Comparative Example C2

The catalyst was synthesized analogously to the catalyst described in Comparative Example 1 of EP-A 1 079 452 using Vulcan XC-72 furnace black. The crystallite size of the Pt crystallites is 3.8 nm.

### Results for Examples 1 to 5 and Comparative Examples C1 and C2

The electrolyte catalysts were converted into a membrane electrode unit for electrochemical characterization. The cathode and anode catalysts were applied to an ion-conductive membrane (Neosepta CMX, manufacturer: Tokuyama Europe GmbH, Düsseldorf, based on sulfonated polystyrene) by the method described in U.S. Pat. No. 5,861,222 (Comparative Example 1). The membrane coated in this way is placed between two conductive, hydrophobicized carbon papers (manufacturer: Toray Industries Inc., Tokyo). The cathode and anode side were each coated with 0.25 mg of platinum/cm². The membrane electrode units obtained in this way were measured in a PEM individual cell (pressureless operation, temperature 80° C.), with a cell voltage of 700 mV being set.

The following table shows the cell power after operation for 100 and 1500 hours for each of the catalysts used:

| | Cell power at | Cell power at |
|---|---|---|
| | 700 mV [mA/cm²] | 700 mV [mA/cm²] |
| | after operation | after operation |
| Catalyst | for 100 hours | for 1500 hours |
| Example 1 | 230 | 232 |
| Example 2 | 256 | 253 |
| Example 3 | 244 | 241 |
| Example 4 | 260 | 261 |
| Example 5 | 244 | 245 |
| Comparative Example C1 | 240 | 183 |
| Comparative Example C2 | 245 | 175 |

At 700 mV and in the time between 100 and 1500 operating hours, the cell power in fuel cells in accordance with the state of the art (comparative examples) falls. In Comparative Example 1, it decreases by 24% and in Comparative Example 2 by 28%. However, the fuel cells according to the invention (Examples 1 to 5) exhibit no degradation effects. The cell power in the fuel cells according to the invention remains unchanged, within the bounds of measurement error, in the time between 100 and 1500 operating hours. The present invention considerably improves the economic efficiency, the efficiency and the service life of the fuel cells according to the invention compared with the fuel cells known hitherto.

List of Reference Numerals

1 Fuel cell

2 Electrodes

3 Substrate

4 Electrocatalytic layers

5 Gap

6 Membrane

7 Reaction gases

8 Gas transport

9 Ion transport

We claim:

1. A fuel cell having two electrodes and an ion exchanger membrane, where the electrodes are each provided with an electrocatalytic layer and at least one gas channel for a reaction gas, and the respective electrocatalytic layer comprises at least one standard catalyst, wherein the fuel cell has at least one additive which prevents the formation of peroxides and/or destroys peroxides.

2. A fuel cell as claimed in claim 1, wherein the at least one additive comprises at least one element or at least one compound from the group consisting of metallic transition elements or from main group 4 of the Periodic Table of the Elements.

3. A fuel cell as claimed in claim 1, wherein the at least one additive comprises at least one of the elements Co, Fe, Cr, Mn, Cu, V, Ru, Pd, Ni, Mo, Sn and W.

4. A fuel cell as claimed in claim 2, wherein the elements present in the at least one additive are in elemental form or in the form of salts, oxides or organometallic complexes, or combinations thereof.

5. A fuel cell as claimed in of claim 2, wherein the elements and/or compounds present are in heterogeneous form in combination with at least one support substance.

6. A fuel cell as claimed in claim 5, wherein a support substance from the group consisting of C, SiO₂, Al₂O₃, zeolites and heteropolyacids is selected.

7. A fuel cell as claimed in of claim 1, wherein the at least one additive is a constituent of the electrocatalytic layer.

8. A fuel cell as claimed in claim 1, wherein the at least one additive is in the form of a coating on the electrodes and/or is in each case distributed throughout the electrodes.

9. Method in the prevention of the formation or destruction of peroxides on or in the electrodes or for both using at least one additive in or on electrodes of a fuel cell having an ion exchanger membrane, where the electrodes are each provided with an electrocatalic layer and at least one gas channel for a reaction gas, and the at least one addition serves.
